(19) United States
(12) Patent Application Publication
(10) Pub. No.: US 2008/0019876 A1
(43) Pub. Date: Jan. 24, 2008

(54) Sensing Apparatus with Noble Metal and Sensing System and Method Thereof

(76) Inventors: Lai-Kwan Chau, Chiayl City (TW); Wen-Hsin Hsieh, Taipei City (TW); Po-Liang Chen, Wugu Township (TW); Kaua-Ciih Chiu, Tajnan City (TW); Wei-Ting Hsu, Jhonghe City (TW)

Correspondence Address: LAW OFFICES OF LAI AND ASSOCIATES, P.C., 5800 RANCHESTER STE 200, HOUSTON, TX, 77036, US

(21) Appl. No.: 11/612,950

(22) Filed: Dec. 19, 2006

(30) Foreign Application Priority Data
Dec. 20, 2005 (TW) 094145360

(51) Int. Cl. G01N 21/00

(52) U.S. Cl. 422/82.05

(57) ABSTRACT

This invention discloses a sensing apparatus with noble metal and sensing system and its method. The sensing apparatus with noble metal comprises a planar waveguide, a noble metal nano-particle layer, and a cover. The planar waveguide has a top plane. The noble metal nano-particle layer is uniformly distributed on the top plane of the planar waveguide. The cover has a notch, and is covered on the top plane of the planar waveguide to form a space between the notch and the top plane. Accordingly, a plurality of incident lights are led into the sensing apparatus with noble metal nano-particle to detect a testing substance contained in the aforesaid space.

### FIELD OF THE INVENTION

The present invention relates to a sensing apparatus with noble metal and sensing system and its method, and more particularly to a sensing apparatus that combines noble metal nano-particles on a planar waveguide.

### BACKGROUND OF THE INVENTION

In various analysis technologies, the detection of the binding reactions between biological molecules and the quantitative analysis of low level of biological molecules are useful for understanding the reaction characteristics of the biological molecules. For instance, the understanding of the interactions between antibodies and antigens is very important to the applications in the areas of biology, immunization and pharmacy, etc, and thus the development of biological analysis technology enables the understanding of the reaction characteristics of biological molecules. Current research methods include the use of fluorescence, surface plasmon resonance, mass spectrometric analysis and chemiluminescence for detecting protein-protein interactions, and the objective of those researches focuses on exploring the kind of reaction and reaction features of the proteins, so as to provide related information of the biological system, wherein the surface plasmon resonance is a detection method that requires no labeling of the molecules in the testing sample and features real-time monitoring, short analysis time and high sensitivity, and thus such method is welcome by the related industry.

The surface plasmon resonance phenomenon is that when light of a specific frequency illuminates a metal surface, the free electrons will conduct a group dipole oscillation. Therefore, the characteristics can be observed from the incidence of a light source. The intensity of a reflected light at the interface of an optical transmitting material and a metal material drops at a specific angle, and such drop is caused by an excitation of surface plasmon resonance so that the incident light at a specific angle is absorbed and thus a drop of light intensity of the reflected light can be observed and detected.

Referring to FIG. 1 for a schematic view of a conventional sensing apparatus made by a surface plasmon resonance, the apparatus plates a layer of noble metal film 12 on the surface of a prism 11. If a testing sample 13 is placed onto the surface of the noble metal film 12, the angle of incidence of the incident light 14 to produce surface plasmon resonance is changed from that without the testing sample 13. Therefore, the characteristics of the testing sample 13 can be revealed by the change of the intensity of the reflected light 15 or the resonance angle 0.

Since the sensing apparatus of the surface plasmon resonance comes with a high sensitivity, it is not necessary to make any labeling for the molecules of the testing sample in order to analyze the interaction between molecules in real-time. The detection speed is fast and thus such sensing apparatus can be used extensively for the analysis of biological molecules. Although the sensitivity of the sensing apparatus is good, the optical design is bulky and expensive. Nowadays, the trend of sensing apparatus development tends to be small and compact. If the detection method and optical design of the sensing apparatus can be simplified to make the sensing apparatus less bulky and expensive, the value of the applications of the sensing apparatus will be increased greatly.

In recent years, nano materials are developed rapidly, and researches and applications of nano materials are applied extensively in the areas of optoelectronics, communications and medical instruments. Nano materials become very popular, because the nano materials have properties different from bulk materials. Noble metal nano-particles exhibiting a Localized Surface Plasmon Resonance (LSPR) can be utilized to replace propagating surface plasmon resonance (PSPR) associated with traditional noble metal thin film. The sensitivity of the sensor is still good and other features such as pixel size and simplicity in construction of the sensor are then improved.

To meet the requirement of miniaturizing the foregoing sensing apparatus, the inventor based on years of experience of the related industry from conduct extensive research and experiments, invents a sensing apparatus containing noble metal and sensing system and its method in hope of overcoming the foregoing shortcomings of the prior art.

### SUMMARY OF THE INVENTION

Therefore, a primary objective of the present invention is to provide a sensing apparatus with noble metal and sensing system and its method, and more particularly a sensing apparatus that combines noble metal nano-particles onto a planar waveguide.

To achieve the foregoing objective, the present invention provides a sensing apparatus containing noble metal that comprises a planar waveguide, a noble metal nano-particle layer and a cover. The planar waveguide has a top plane, a noble metal nano-particle layer uniformly distributed on the top plane of the planar waveguide. The cover has a notch on the top plane of the planar waveguide that forms a space between the notch and the top plane.

Accordingly, a plurality of incident lights are led into the sensing apparatus containing noble metal nano-particle to accomplish the goal of detecting a testing substance stored in aforesaid space by utilizing the sensing system.

To make it easier for our examiner to understand the objective of the invention, its structure, innovative features, and performance, the inventor uses a preferred embodiment together with the attached drawings for the detailed description of the invention.

### BRIEF DESCRIPTION OF THE DRAWINGS

FIG. 1 is a schematic view of a conventional sensing apparatus made by a surface plasmon resonance;

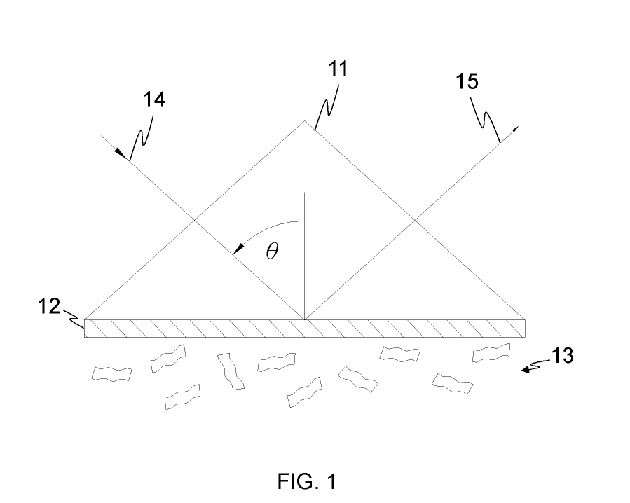

FIG. 2 is a cross-sectional view of a sensing apparatus with noble metal in accordance with a preferred embodiment of the present invention;

FIG. 3 is a perspective view of a cover in accordance with another preferred embodiment of the present invention;

FIG. 4 is a perspective view of a sensing apparatus with noble metal in accordance with another preferred embodiment of the present invention;

FIG. 5A is a schematic view of a sensing system with noble metal in accordance with a preferred embodiment of the present invention;

FIG. 5B is a schematic view of a sensing system with noble metal in accordance with another preferred embodiment of the present invention;

FIG. 5C is a schematic view of a sensing system with noble metal in accordance with a further preferred embodiment of the present invention;

FIG. 6 is a schematic view of a detection performed by a sensing system with noble metal in accordance with a preferred embodiment of the present invention;

FIG. 7 is a flow chart of a sensing method with noble metal in accordance with a preferred embodiment of the present invention; and

FIG. 8 is a flow chart of a sensing method with noble metal in accordance with another preferred embodiment of the present invention.

### DETAILED DESCRIPTION OF THE PREFERRED EMBODIMENTS

The above objective, features and advantages of the sensing apparatus with noble metal and sensing system and its method in accordance with the present invention will become apparent from the following detailed description taken with the accompanying drawing. For simplicity, numerals adopted for elements in the following embodiment are the same as the numerals adopted for elements in the previous embodiment.

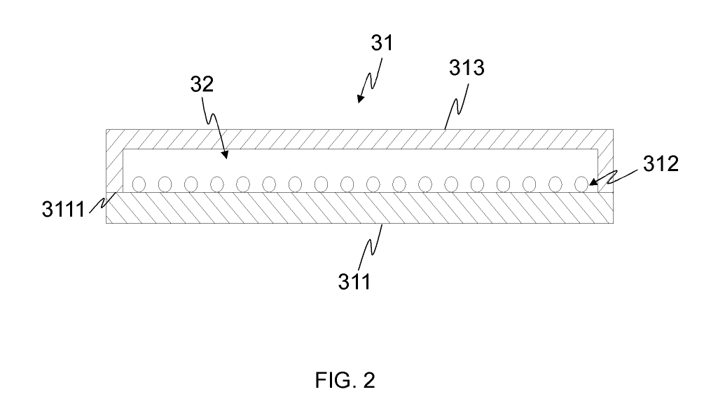

Referring to FIG. 2 for a cross-sectional view of a sensing apparatus with noble metal in accordance with a preferred embodiment of the present invention, the sensing apparatus with noble metal 31 comprises a planar waveguide 311 and a noble metal nano-particle layer 312 further comprises a cover 313. The planar waveguide has a top plane 3111, and the noble metal nano-particle layer 312 is uniformly distributed on a top plane 3111 of the planar waveguide 311. The cover 313 has a notch, and is covered on the top plane 3111 of the planar waveguide 311 to form a space 32 between the notch and the top plane 3111.

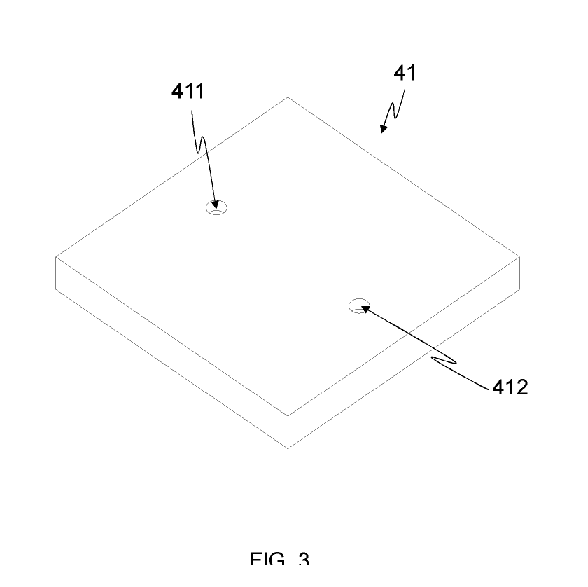

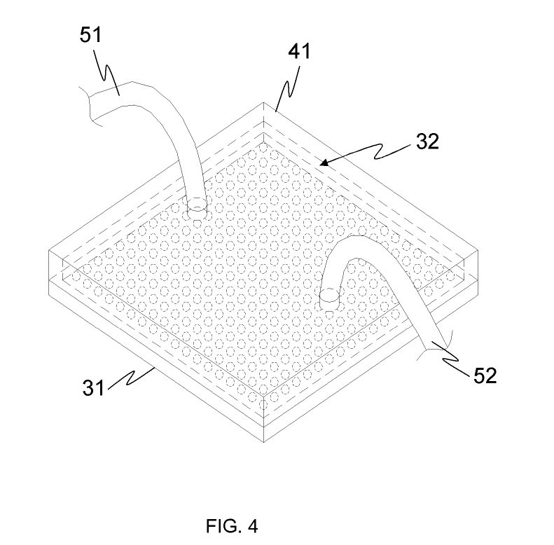

Referring to FIGS. 3 and 4 for a perspective view of a cover in accordance with another preferred embodiment of the present invention respectively, the cover 41 has two holes 411, 412 for containing a testing sample, and one hole is an inlet and the other hole is an outlet as shown in FIG. 3. The sensing apparatus with noble metal 31 as shown in FIG. 4 adopts the cover 41 as shown in FIG. 3, and the two holes 411, 412 of the cover 41 are connected to two ducts 51, 52 respectively for leading the testing sample, so that the testing sample can be led into the space 32 through the ducts 51, 52 and the holes 411, 412.

In FIGS. 2 to 4, the planar waveguide generally can be a single-mode or a multi-mode waveguide plate. The noble metal nano-particle layer is made of a plurality of gold nano-particles, a plurality of silver nano-particles or a plurality of platinum nano-particles. The cover is generally made of a transparent material. The testing sample generally consists of a biological substance such as protein and DNA.

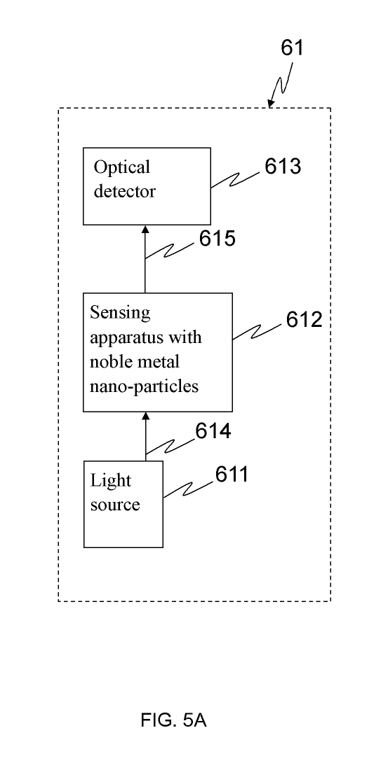

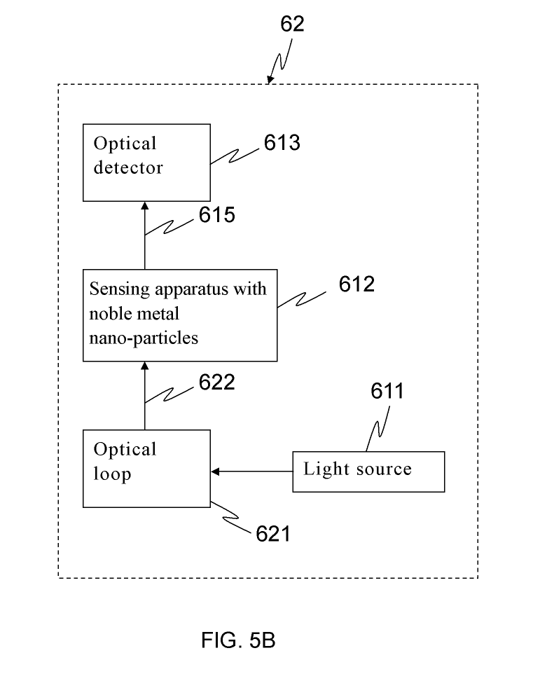

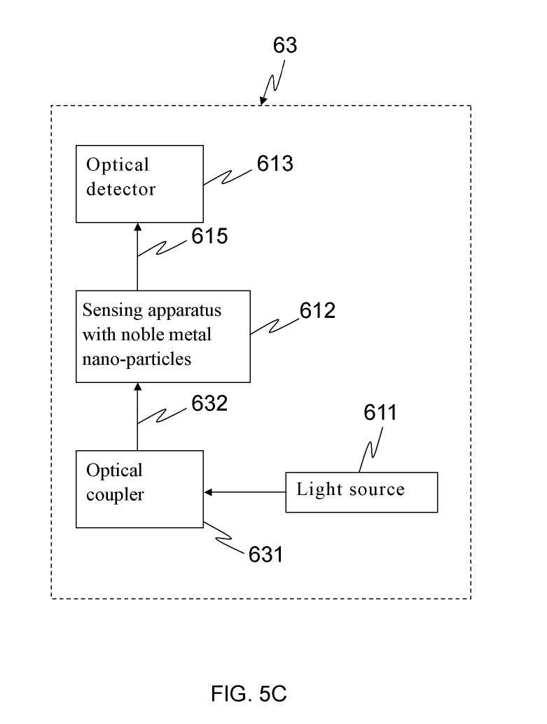

Referring to FIG. 5A for a schematic view of a sensing system with noble metal in accordance with a preferred embodiment of the present invention, the sensing system with noble metal 61 comprises a light source 611, a sensing apparatus with noble metal nano-particles 612 and at least one optical detector 613. The light source 611 provides an incident light 614, a sensing apparatus with noble metal nano-particles 612 for producing a surface plasmon on a planar waveguide by the noble metal nano-particles and contacting with a testing substance, and leading the aforesaid incident light 614 to have a surface plasmon resonance. The optical detector 613 is provided for detecting at least one emergent light 615 emerged from the sensing apparatus to determine the testing substance.

Referring to FIGS. 5B and 5C for the schematic views of preferred embodiments of a sensing system with noble metal of the present invention, the sensing system with noble metal 62 as shown in FIG. 5B comprises a light source 611, a sensing apparatus with noble metal nano-particles 612 and an optical detector 613. The sensing system with noble metal 62 further comprises an optical loop 621 for dividing the light from light source 611 and producing a plurality of incident lights 622 to be incident into the sensing apparatus containing noble metal nano-particles 612. The sensing system with noble metal 63 as shown in FIG. 5C comprises the aforesaid light source 611, sensing apparatus with noble metal nano-particles 612 and optical detector 613. The sensing system with noble metal 63 further comprises an optical coupler 631 for coupling the light from light source 611 and producing an incident light 632 to be incident into the sensing apparatus with noble metal nano-particles 612.

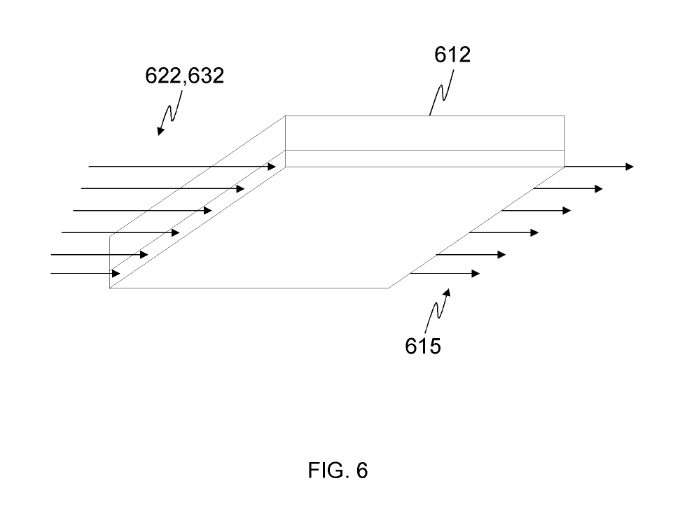

Referring to FIG. 6 for a schematic view of a detection performed by a sensing system with noble metal in accordance with a preferred embodiment of the present invention, the sensing apparatus with noble metal nano-particles 613 guides a plurality of incident lights 622, 632 provided by an optical loop 621 or an optical coupler 631 as shown in FIGS. 5B and 5C respectively, such that at least one emergent light 615 emitted from the sensing apparatus can be detected by the optical detector 613 as shown in FIGS. 5B or 5C, and then a complete detection result can be collected to determine the testing substance, so as to accomplish the goal of detecting a testing substance.

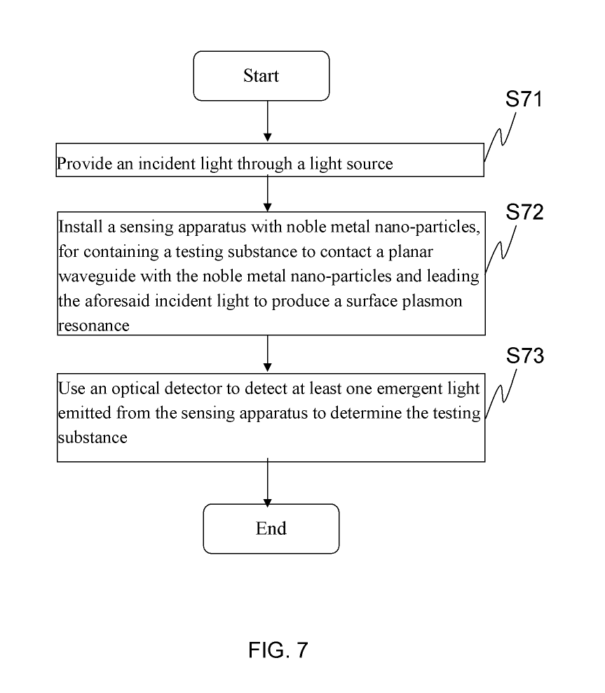

Referring to FIG. 7 for a flow chart of a sensing method with noble metal in accordance with a preferred embodiment of the present invention, the flow chart of this method comprises the steps of:

Step S71: providing an incident light through a light source;

Step S72: installing a sensing apparatus with noble metal nano-particles, for containing a testing substance to contact a planar waveguide with the noble metal nano-particles and leading the aforesaid incident light to produce a surface plasmon resonance; and

Step S73: using an optical detector to detect at least one emergent light emitted from the sensing apparatus to determine the testing substance.

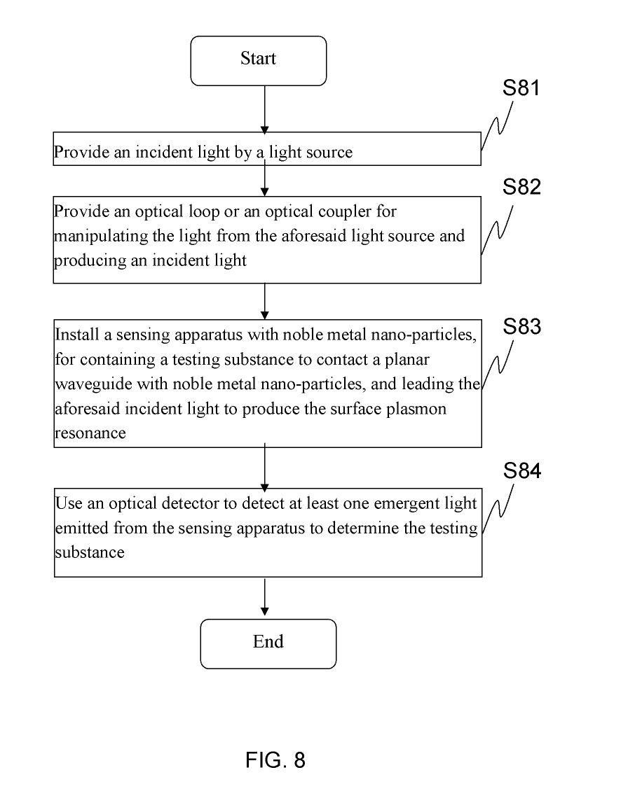

Referring to FIG. 8 for a flow chart of a sensing method with noble metal in accordance with another preferred embodiment of the present invention, the flow chart of this method comprises the steps of:

Step S81: providing an incident light by a light source;

Step S82: providing an optical loop or an optical coupler, for manipulating the light from the aforesaid light source and producing an incident light;

Step S83: installing a sensing apparatus with noble metal nano-particles, for containing a testing substance to contact a planar waveguide with noble metal nano-particles, and leading the aforesaid incident light to produce a surface plasmon resonance; and

Step S84: using an optical detector to detect at least one emergent light emitted from the sensing apparatus to determine the testing substance.

The optical loop is made of at least one optical component, and usually a polarizer.

In FIGS. 5A, 5B, 5C, 6, 7 and 8, the light source is generally a single-frequency light, a narrowband light or a white light. The sensing apparatus with noble metal nano-particles is a multi-mode or a single-mode waveguide plate made of noble metal nano-particles on a planar waveguide, and the noble metal nano-particles are generally a plurality of gold nano-particles, a plurality of silver nano-particles or a plurality of platinum nano-particles, and the incident or emergent light can be a transverse magnetic (TM) polarized light wave and a transverse electric (TE) polarized light wave, wherein the transverse electric polarized light wave can be used to compensate background changes.

While the invention has been described by way of examples and in terms of preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A sensing apparatus with noble metal, comprising:
a planar waveguide, having a top plane; and
a noble metal nano-particle layer, distributed on said top plane of said planar waveguide.

2. The sensing apparatus with noble metal of claim 1, further comprising a cover for covering said top plane of said planar waveguide, and a notch for forming a space with said top plane.

3. The sensing apparatus with noble metal of claim 2, wherein said cover includes at least two holes, such that a testing substance is contained in said space through said holes.

4. The sensing apparatus with noble metal of claim 3, wherein said holes include at least one outlet and at least one inlet.

5. The sensing apparatus with noble metal of claim 1, wherein said planar waveguide is a single-mode waveguide plate or a multi-mode waveguide plate.

6. The sensing apparatus with noble metal of claim 1, wherein said noble metal nano-particle layer is composed of a plurality of gold nano-particles, a plurality of sliver nano-particles or a plurality of platinum nano-particles.

7. A sensing system with noble metal, comprising:
a light source, for providing an incident light;
a sensing apparatus with noble metal nano-particles for producing a surface plasmon resonance on a surface of a planar waveguide by said noble metal nano-particles and contacting a testing substance, and leading said incident light to produce a surface plasmon resonance; and
at least one optical detector, for detecting at least one emergent light emerged from said sensing apparatus to determine said testing substance.

8. The sensing system with noble metal of claim 7, wherein said light source is a single-frequency light, a narrowband light, or a white light.

9. The sensing system with noble metal of claim 7, further comprising an optical loop for dividing the light from said light source to be incident into said sensing apparatus with noble metal nano-particles.

10. The sensing system with noble metal of claim 7, further comprising an optical coupler for coupling the light from said light source to be incident into said sensing apparatus with noble metal nano-particles.

11. The sensing system with noble metal of claim 10, wherein said optical loop is comprised of at least one optical component.

12. The sensing system with noble metal of claim 7, wherein said planar waveguide is a single-mode waveguide plate or a multi-mode waveguide plate.

13. The sensing system with noble metal of claim 7, wherein said noble metal nano-particles of said sensing apparatus with noble metal nano-particles are a plurality of gold nano-particles, a plurality of silver nano-particles or a plurality of platinum nano-particles.

14. The sensing system with noble metal of claim 7, wherein said incident or emergent light is a transverse magnetic (TM) polarized light wave or a transverse electric (TE) polarized light wave.

15. A sensing method with noble metal, comprising the steps of:
using a light source to provide an incident light;
installing a sensing apparatus with noble metal nano-particles and containing a testing substance, and producing a surface plasmon on a surface of a planar waveguide by said noble metal nano-particles and contacting with said testing substance, and leading said incident light to produce a surface plasmon resonance; and
using at least one optical detector, for detecting at least one emergent light emerged from said sensing apparatus to determine said testing substance.

16. The sensing method with noble metal of claim 15, further comprising the step of providing a single-frequency light, a narrowband light or a white light as said light source.

17. The sensing method with noble metal of claim 15, further comprising the steps of providing an optical loop to divide the light from said light source to be incident into said sensing apparatus containing noble metal nano-particles.

18. The sensing method with noble metal of claim 15, further comprising the steps of providing an optical coupler to couple the light from said light source to be incident into said sensing apparatus containing noble metal nano-particles.

19. The sensing method with noble metal of claim 17, further comprising the step of providing said optical loop comprised of at least one optical element.

20. The sensing method with noble metal of claim 15, further comprising the step of providing a single-mode waveguide plate or a multi-mode waveguide plate as said planar waveguide.

21. The sensing method with noble metal of claim 15, further comprising the step of providing a plurality of gold nano-particles, a plurality of silver nano-particles or a plurality of platinum nano-particles as said noble metal nano-particles for said sensing apparatus with noble metal nano-particles.
